(19) United States
(12) Patent Application Publication
(10) Pub. No.: US 2018/0302269 A1
(43) Pub. Date: Oct. 18, 2018

(54) Failover in a Media Access Control Security Capable Device

(71) Applicant: Hewlett Packard Enterprise Development LP, Houston, TX (US)

(72) Inventors: Balaji Sankaran, Bangalore (IN); Badrish Havaralu Rama Chandra Adiga, Bangalore (IN); Venkatesh Natarajan, Bangalore (IN)

(21) Appl. No.: 15/946,213

(22) Filed: Apr. 5, 2018

(30) Foreign Application Priority Data
Apr. 17, 2017 (IN) IN 201741013623

(51) Int. Cl. H04L 12/24; H04L 29/06

(52) U.S. Cl. CPC H04L 41/0654; H04L 63/0428; H04L 63/162

(57) ABSTRACT

Examples disclosed herein relate to providing a failover in a MACsec capable device. In an example, a primary management engine that runs a protocol of MACsec standard in a MACsec capable device may determine whether a parameter related to a protocol of MACsec standard on the MACsec capable device has changed. In response to the determination that the parameter has changed, primary management engine may synchronize data related to the parameter to a secondary management engine, which acts as a failover component for the primary management engine. In response to a determination that the primary management engine has failed, secondary management engine may recreate the latest state of the protocol of MACsec standard in the MACsec capable device prior to the failure of the primary management engine, based on the data related to the parameter.

### BACKGROUND

Media Access Control Security (MACsec) is a technology that may provide secure communication on Ethernet links. MACsec may allow unauthorized Local Area Network (LAN) connections to be identified and excluded from communication within a network. MACsec may provide data confidentiality, data integrity and data origin authentication on Ethernet links between nodes.

### BRIEF DESCRIPTION OF THE DRAWINGS

For a better understanding of the solution, examples will now be described, purely by way of example, with reference to the accompanying drawings, in which:

FIG. 1 illustrates a block diagram of an example computing environment for providing a failover in a MACsec capable device;

FIG. 2 is a bock diagram of an example MACsec capable device for providing a failover;

FIG. 3 is a flow chart of an example method of providing a failover in a MACsec capable device; and

FIG. 4 is a block diagram of is a block diagram of an example system including instructions in a machine-readable storage medium for providing a failover in a MACsec capable device.

### DETAILED DESCRIPTION

Media Access Control security (MACsec) is an IEEE 802 standard that specifies how to secure all or part of a LAN at the link layer. MACsec executes the encryption function in the physical layer (PHY) of an Ethernet port and offers encryption equal to that of the Ethernet port rates bi-directionally regardless of the packet size. MACsec may secure participating entities (for example, network devices) using the MACsec Key Agreement (MKA) protocol.

Enterprises are increasingly focusing on securing networks from the inside, and MACsec as layer 2 security protocol may help fill this gap. To ensure the security of wired networks, it may be desirable to implement the MACsec functionality on newer generation of network infrastructure switches. However, currently, the scope of IEEE 802.1X-2010 standard is limited to providing, for example, compatible authentication, authorization, and cryptographic key agreement mechanisms to support secure communication between devices. It does not address high availability feature from the perspective of network devices like switches, routers etc. As used herein, “high availability” may refer to a system or component that is continuously operational for a desirably long length of time. In the context of MACsec, it may be desirable to offer high availability in a MACsec capable device. If a system running MACsec crashes, it may be desirable for the system to recover itself in very short span of time without affecting data traffic.

In an example, if an entity that manages a Connectivity Association (CA) goes down, all Secure Channels (SCs) and Secure Association (SA) in the CA may get deleted which may affect data traffic. Thus, it is desirable that a MACsec CA is kept alive even after failover. In an example, a CA may be kept alive by exchanging keepalive MICA packets. The default transmit interval for a MKA keepalive message (MKA_TRANSMIT_INTERVAL) is two seconds. This means that once CA is formed, the MKA packets may be exchanged between the peers participating in the CA for every two seconds to keep the session alive. And, if a MACsec peer is not able to receive MKA packets from the crashed device for more than (3*MKA_TRANSMIT_INTERVAL), it may dissolve the CA by purging all SCs and SAs in the CA. For example, if (t) seconds is the time at which last MKA packet was sent out, and if the MACsec capable device crashes at (t+1.9999) seconds, this gives milliseconds of time buffer for the crashed device to recreate the original state. It may be desirable for the device to recover itself in this short span of time without affecting data traffic.

To address these issues, the present disclosure describes various examples for providing a failover in a MACsec capable device. In an example, a primary management engine in a Media Access Control (MAC) Security (MACsec) capable device may determine whether a parameter related to a protocol of MACsec standard on the MACsec capable device has changed. The primary management engine may be responsible for running a protocol of MACsec standard in the MACsec capable device. In response to the determination that the parameter related to the protocol of MACsec standard on the MACsec capable device has changed, the primary management engine may synchronize data related to the parameter to a secondary management engine in the MACsec capable device. The secondary management engine may act as a failover component for the primary management engine. In response to a determination that the primary management engine has failed, the secondary management engine may recreate the latest state of the protocol of MACsec standard in the MACsec capable device prior to the failure of the primary management engine, based on the data related to the parameter. Examples described herein provide mechanisms for failover of 802.1X MACsec operations in high availability systems.

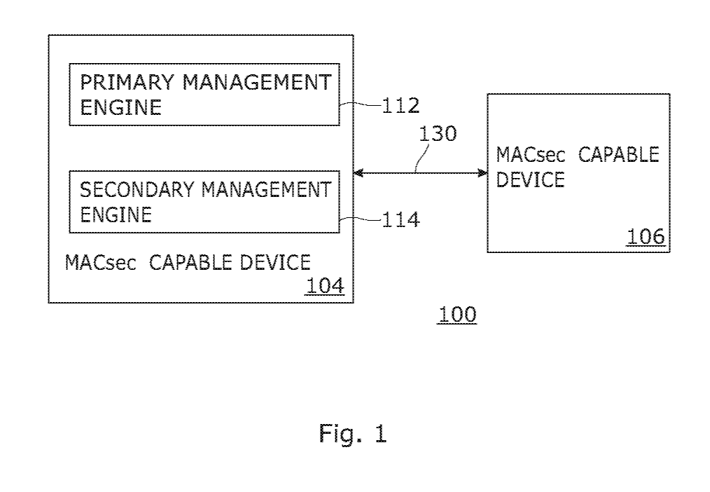

FIG. 1 illustrates a block diagram of an example computing environment 100 for providing a failover in a MACsec capable device. The computing environment 100 may include MACsec capable devices 104 and 106. Although two MACsec capable devices are shown in FIG. 1, other examples of this disclosure may include more than two MACsec capable devices.

In an example, MACsec capable devices 104 and 106 may each be a network device. For example, MACsec capable devices 104 and 106 may each be a network switch, a network router, a virtual switch, and a virtual router. In another example, MACsec capable devices 104 and 106 may each be a computing device capable of executing machine-readable instructions. For example, MACsec capable devices 104 and 106 may each be a server, a desktop computer, a notebook computer, a tablet computer, a thin client, a mobile device, a personal digital assistant (PDA), and the like.

MACsec capable devices 104 and 106 may be communicatively coupled, for example, via a computer network 130. Computer network 130 may include, for example, a Local Area Network (LAN), and a Wireless Local Area Network (WAN).

As used herein, a “MACsec capable device” may include a device that supports MACsec. As mentioned earlier, MACsec is the IEEE 802.1AE standard for authenticating and encrypting packets between two MACsec-capable devices (for example, 104 and 106). A MACsec capable device (for example, 104 and 106) may support 802.1AE encryption with MACsec Key Agreement (MKA) on downlink ports for encryption between the MACsec device and a host device. A MACsec capable device may support MACsec link layer between MACsec capable device-to-MACsec capable device security.

MACsec standard may provide MAC-layer encryption over wired networks by using out-of-band methods for encryption keying. MACsec standard may include several protocols. These may include, for example, Extensible Authentication Protocol (EAP), MACsec Key Agreement (MKA), Security Association Protocol (SAP), EAP over LAN (EAPOL), Remote Authentication Dial-In User Service (RADIUS) protocol, etc.

The MKA Protocol manages the encryption keys used by the MACsec protocol. The MKA Protocol allows peer discovery with confirmation of mutual authentication and sharing of MACsec secret keys to protect data exchanged by the peers.

A Connectivity Association (CA) may be a logical association between two or more MACsec participating entities (for example, network devices). A secure Connectivity Association (CA) may be defined as a security relationship, established and maintained by key agreement protocols, that comprises a fully connected subset of the service access points in stations attached to a single LAN that are to be supported by MACsec. Members of a CA may be identified via a secret key called as secure Connectivity Association Key (CAK). A CAK may be identified via a secure Connectivity Association Key Name (CKN), which may be of 1 to 32 octets. Only entities with same pair of CAK and CKN may be able to form a CA.

A CA may be realized via Secure Channels (SC) between two or more MACsec entities participating in a CA. A secure channel” may refer to a security relationship used to provide security guarantees for frames transmitted from one member of a CA to the others. There may be one SC (“Transmit SC”) for secure transmission of frames from a MACsec entity to all other devices in a CA. However, there may be one or multiple SCs (“Receive SCs”) for receiving frames from other devices in a CA. Each SC may be identified via a Secure Channel Identifier (SCI), which may be a globally unique identifier for a secure channel, comprising a globally unique MAC Address and a Port Identifier, unique within the system that has been allocated that address. A SC remains alive until the two entities participate in the MACsec CA.

MACsec may introduce an additional transit delay due to the increase in the MAC Service Data Unit (MSDU) size. MACsec defines how a MAC Security Entity (SecY) operates with a MAC Security Key Agreement Entity (KaY). Each KaY may discover, authenticate, and/or authorize the KaYs present in other devices on the same LAN. The secure relationships maintained by KaYs are used by SecYs to transmit and receive frames. MACsec protocol below entities. KaY may be responsible for maintenance of MACsec CA, and SecY may be responsible for maintenance of SC and SAs.

MKA provides a method for discovering MACsec peers and negotiating the security keys needed to secure a link. Two methods may be utilized to derive the MACsec encryption keys: manual pre-shared keys or Extensible Authentication Protocol (EAP). When pre-shared keys method is used, the pre-shared key is the connectivity association key (CAK). The root key in the MACsec Key Agreement key hierarchy is the Connectivity Association Key (CAK), and is identified by a CAK Name (CKN). MKA does not use the CAK directly but derives two further keys from the CAK using the Advanced Encryption Standard (AES) key wrap algorithm. These include the ICV Key (ICK) used to verify the integrity of MACsec Key Agreement Protocol Data Units (MPDUs) and to prove that the transmitter of the MKPDU possesses the CAK, and the Key Encrypting Key (KEK) used by Key Server to transport SAKs to the other member(s) of a CA. CAK may be used to generate the rest of the MACsec encryption keys (for example, ICK, KEK, and SAK). ICK and KEK derived from a CAK may be used to distribute SAKs to systems that possess that CAK.

MICA and MACsec may be implemented after successful authentication using the 802.1x Extensible Authentication Protocol (EAP) framework. The EAP framework implements MKA as a newly defined EAP-over-LAN (EAPOL) packet. Entering the EAP session ID generates a secure CKN. The packet body in an EAPOL Protocol Data Unit (PDU) is referred to as a MACsec Key Agreement PDU (MKPDU).

SAs (Secure Associations) are rolling sessions over a SC wherein each SA may be valid for a fixed number of packets. Each SA created may be identified by a SC Identifier (SCI) concatenated with an Association Number (AN). A “'secure association” may be defined as a security relationship that provides security guarantees for frames transmitted from one member of a CA to the others. Each SA is supported by a single secret key (for example, SAK) or a single set of keys. Thus, a SAK is a secret key used by an SA. A SA may be globally identified by constructing SCI and AN together. A SAK may be valid till 2³² numbers of packets are exchanged between two entities on a SC, before rolling over for a new SA with a new SAK. Once the number of packets exchanged between two entities on an SC reaches 2²⁰, a “SAK rotation” is initiated. A new SA may be formed with new SAK and a timer may be started for three seconds. Upon expiry of three seconds, the old SA may be purged. Thus, after SAK rotation, there may be two SAs for three seconds of time. During this period, a MACsec PHY is expected to decrypt received MACsec frames encrypted by any of the 2 SAKs.

SAK may be used to provide data confidentiality by encrypting/decrypting a packet. The SAK may be exchanged between the MACsec entities over the MACsec Key Agreement (MKA) protocol. In an example, one of the entities participating in CA may be elected as Key Server whose responsibility is to generate and distribute new SAKs whenever SAK needs to be rotated. To distribute new SAKs securely over a link, Key Server may uses KEK to encrypt the SAK using AES Key wrap algorithm, and the key wrap may be transmitted to Non-Key Servers.

In the pre-shared key method of deriving MACsec encryption keys, the same pre-shared key (CAK) may be configured by a user on the MACsec entities that are to become members of the same CA. Each participant may derive other keys (ICK and KEK) from the pre-shared key using the same algorithm (and parameters). In an example, this method may be used on a point-to-point link with two participants (for example, network devices 104 and 106).

Using the MKA protocol, the CKN may be exchanged to authenticate each participant mutually and the MKA protocol may maintain MACsec on the link. The MKA protocol may be used to select one of the two participants on the point-to-point link as Key Server. The Key Server then creates a randomized encryption key (SAK) that is shared in a secure manner with the other participant. The Key Server may continue to periodically (until a packet number limit is reached) create and share a new randomly generated SAK over the point-to-point link as long as MACsec secure connectivity is maintained.

In some examples, at least one of the MACsec capable devices 104 or 106 may include a primary management engine 112 and a secondary management engine 114. For the sake of simplicity in illustration, MACsec capable device 104 is shown to include primary management engine 112 and secondary management engine 114. However, any other MACsec capable device (for example, 106) in the computing environment 100 may include these engines as well.

Engines 112 and 114 may include any combination of hardware and programming to implement the functionalities of the engines described herein. In examples described herein, such combinations of hardware and software may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one engine of MACsec capable device (for example, 104 and 106). In some examples, the at least one machine-readable storage medium may store instructions that, when executed by the at least one processing resource, at least partially implement some or all engines of the computing device. In such examples, MACsec capable device (for example, 104 and 106) may include the at least one machine-readable storage medium storing the instructions and the at least one processing resource to execute the instructions.

In an example, primary management engine 112 may run a protocol (for example, MKA) related to MACsec standard in MACsec capable device 104. Primary management engine 112 on MACsec capable device 104 may determine whether a parameter related to MACsec standard on MACsec capable device 104 has changed. In an example, primary management engine 112 on MACsec capable device 104 may determine whether a parameter related to MACsec standard on a peer MACsec capable device (for example, 106) has changed. In an example, when a link is first established between MACsec capable devices 104 and 106, they become peers. Mutual peer authentication may take place by configuring a pre-shared key (CAK), as described earlier. On successful peer authentication, a connectivity association may be formed between the peers, and a secure CKN may be exchanged between MACsec capable devices 104 and 106 to authenticate each participant, and the MKA protocol enables and maintains MACsec on the link. A security association may be formed between peer MACsec capable devices 104 and 106. The MKA protocol may be used to select one of the two participants (104 and 106) on the point-to-point link as Key Server. A Key Server may be selected between MACsec capable devices 104 and 106, based on the configured key server priority. Each participant in an MKA instance with a CAK may uses the Key Server Priority (an 8-bit integer) encoded in each MKPDU to agree on the Key Server. Each such participant may select the live participant advertising the highest priority as its Key Server whenever the Live Peers List changes, provided that highest priority participant has not selected another as its Key Server or is unwilling to act as the Key Server. In the event of a tie for highest priority Key Server, the member with the highest priority SCI may be chosen as the Key Server.

The Key Server may create a randomized encryption key (SAK) that is shared in a secure manner with the other participant. The Key Server may continue to periodically (until a packet number (PN) limit is reached) create and share a new randomly generated SAK over the point-to-point link for as long as MACsec secure connectivity is maintained. A packet number (PN) may refer to a monotonically increasing value used to uniquely identify a MACsec frame in the sequence of frames transmitted using an SA.

In an example, the connectivity association between peer MACsec capable devices 104 and 106 may be kept alive by exchanging MKA keepalive messages. The MKA protocol defines a keepalive packet that is sent every two seconds for a MACsec session. If more than three keepalives go unanswered, a participant may tear down the session. The MKA timeout is therefore six seconds. The MKA keepalive function is always operational on MACsec sessions, and does not require configuration.

An MKA keepalive message may include data related to various parameters of an MKA. This may include, for example, data related to Basic Parameter Set, Live Peer List, Potential Peer List, and MACsec SAK Use. The Basic Parameter Set may be used to advertise the capabilities and identity of a peer participating in a MKA session (MACsec CA). The Basic Parameter Set may include parameters, for example, MKA Version Identifier, Key Server Priority, MACSec Desired, MACsec Capability, SCI, and CAK name. The Live Peer List and Potential Peer List parameter sets may include a list of peer participants in a MKA session, wherein each peer is uniquely identified by a Member Identifier (MI). The MACsec SAK Use parameter set may include details of SAK in use in the secure associations of a CA. The MACsec SAK Use parameter set may include parameters, for example, Latest Key AN, Old Key AN, Latest Key Identifier, Latest Key Lowest Acceptable PN, Old Key Identifier, and Old Key Lowest Acceptable. The Distributed SAK parameter set may include data related to a SAK distributed by Key Server. The Distributed SAK parameter set may include parameters, for example, AES Key Wrap of SAK, Distributed AN, Offset Confidentiality, and Key Number. More details about these parameter sets may be found in the standard IEEE802.1X-2010. The aforementioned parameter sets may represent various properties of a MACsec capable device (for example, 104 and 106).

In an example, MACsec capable device 104 may receive a keepalive message(s) from MACsec capable device 106. Primary management engine 112 on MACsec capable device 104 may analyze the keepalive message(s) to determine whether a parameter (for example, Basic Parameter Set, Live Peer List, Potential Peer List, and MACsec SAK Use related to MACsec standard) on MACsec capable device 104 has changed.

In response to a determination that a parameter related to MACsec capable device 104 has changed, primary management engine 112 may synchronize data related to the changed parameter to a secondary management engine 114 in MACsec capable device 104. In an example, secondary management engine 114 may represent a failover component for primary management engine 112. Secondary management engine 114 may be configured to run a protocol (for example, MKA) related to MACsec standard in MACsec capable device 104 in the event primary management engine 112 becomes unavailable (for example, in case of failure).

In an example, synchronizing data related to the changed parameter to a secondary management engine 114 in MACsec capable device 104 may include storing data related to the changed parameter to a primary database associated with primary management engine 112. The data in the primary database may be synchronized with a secondary database associated with secondary management engine 114. Secondary management engine 114 may access the secondary database to read data related to the changed parameter.

In another example, synchronizing data related to the changed parameter to a secondary management engine 114 in MACsec capable device 104 may include storing data related to the changed parameter to a common database, which may be accessible to secondary management engine 114. Secondary management engine 114 may access the common database to read data related to the changed parameter.

In an example, the changed parameter may include a controlledPortEnabled status of MACsec capable device 104. A “controlled port” may refer to an access point used to provide a secure MAC Service to a client of SecY. A controlled port may provide secure access-controlled communication on a MACsec capable device (for example, 106). A controlled port may provide full access to a network. When a client is successfully authenticated, the controlled port is opened to the client. By default, all controlled ports on the device are placed in the authorized state, allowing all traffic.

In an example, MACsec capabale devices 104 and 106 may each act as a Port Access Entity (PAE). A “PAE” may refer to the protocol entity associated with a port. The controlled port is manipulated by Port Access Entity to allow (in the authorized state) or prevent (in the unauthorized state) network traffic ingressing and egressing to/from the controlled port. The uncontrolled port is used by PAE to transmit and receive EAPOL frames. A PAE component may support authentication, authorization, and the key agreement functionality defined by IEEE Std 802.1AE to allow a MAC Security Entity (SecY) to protect communication through a port.

The Controlled Port (CP) state machine may be responsible for asserting the controlledPortEnabled signal that a PAE (for example, 104) uses to control the MAC Operational status of a Controlled Port. When controlledPortEnabled is false, the client of the Controlled Port can neither receive nor transmit.

In an example, the changed parameter may include an electedSelf status of MACsec capable device 104. An “electedSelf” status may be used to determine whether the principal actor has been elected Key Server. As used herein, the “principal actor” may refer to an actor participating in a given MKA instance with the highest priority Key Server.

In response to a determination by secondary management engine 114 that the primary management engine 112 has failed, secondary management engine 114 may recreate the latest state of a protocol related to the MACsec standard in the primary management engine 112 prior to the failure, on secondary management engine 114, based on the data related to the parameter. In this regard, secondary management engine 114 may refer to the previously synchronized data. In an example, secondary management engine 114 may refer to the secondary database to read data related to, for example, a changed parameter. In another example, secondary management engine 114 may refer to the common database to read data related to, for example, a changed parameter. Secondary management engine 114 may use the synchronized data to recreate the latest state of a protocol(s) related to MACsec, which were previously run by the primary management engine 112 prior to its failure. Once the state of all previously running protocols related to MACsec are recreated by secondary management engine 114, secondary management engine 114 may become the new primary management engine 112. Recreating the latest state of a protocol(s) related to MACsec by secondary management engine 114 may enable MACsec capable device 104 to maintain a MACsec connectivity association.

In an example, recreating the latest state of a protocol(s) related to MACsec by secondary management engine 114 may include recreating a Controlled Port (CP) State machine state on MACsec capable device 104. In an example, the CP state machine may be created by a daemon in secondary management engine 114.

The Controlled Port (CP) state machine may be responsible for asserting the controlledPortEnabled signal that a PAE (for example, 104) uses to control the MAC Operational status of a Controlled Port. The CP may also control the portValid signal, setting it true when communication through the port is secured by MACsec. The CP state machine may ensure that a new SAK is not distributed until the Key Server is receiving and transmitting using a single SAK.

Controlled Port (CP) state machine may be used to control a SecY. The CP may support interoperability with unauthenticated systems that are not port-based network access control capable, or that lack MKA. When the access controlled port is supported by a SecY, the CP may be capable of controlling the SecY so as to provide unsecured connectivity to systems that implement a Port Access Controller (PAC). A PAC may be a protocol-less shim that provides control over frame transmission and reception by clients attached to its Controlled Port, and uses the MAC Service provided by a Common Port.

In an example, recreating a CP State machine state on MACsec capable device 104 may include determining, by secondary management engine 114, a status of a controlledPortEnabled parameter for a controlled port on MACsec capable device 104. In response to a determination that the status of the controlledPortEnabled parameter is false, it may indicate that a MACsec CA was not established at the time of failure of primary management engine 112. In such case, secondary management engine 114 may create a new connectivity association for MACsec capable device 104.

In an example, recreating a CP State machine state on MACsec capable device 104 may include determining, by secondary management engine 114, a status of a controlledPortEnabled parameter for a controlled port on MACsec capable device 104. In response to a determination that the status of the controlledPortEnabled parameter is true, secondary management engine 114 may enable the Controlled Port (CP) State machine state to a Secure state. In the “Secure state”, secure connectivity is to be provided for a controlled port using SAKs provided by the KaY (when available) and setting controlledPortEnabled when those keys are installed and in use. Secondary management engine 114 may generate a transmit secure channel (SC), and receive secure channels for all live peers of MACsec capable device 104.

Secondary management engine 114 may determine whether an old Secure Association Key (SAK) is transmitting. As mentioned earlier, the Key Server is responsible for generating and distributing MACsec SAKs. A SAK may vary continuously in the same secure channel (SC). Thus, the SC may maintain an old SAK. Even when a new SAK has already been installed, the old SAK may be maintained, for example, for decrypting frames possibly encrypted with the old SAK which may have been temporarily stored in a receiving buffer. In response to a determination that the old SAK is transmitting, secondary management engine 114 may generate a secure association (SA) on the transmit secure channel using the old SAK.

Secondary management engine 114 may determine whether old SAK is transmitting but not receiving. In response to a determination that the old SAK is transmitting but not receiving, secondary management engine 114 may enable CP State machine state to an Assert state. In the “Assert state”, MACsec operation may not be recovered after failover to secondary management engine 114. In the Assert state, MKA & MACsec operations may be started from afresh on the impacted interface of MACsec capable device 104. In response to a determination that old SAK is transmitting but not receiving, secondary management engine 114 may generate secure associations on all receive secure channels using the old SAK. In an example, in response to a determination that old SAK is not transmitting but receiving, secondary management engine 114 may start a timer to purge receive secure channels corresponding to old key.

Secondary management engine 114 may determining a state of the latest SAK. Secondary management engine 114 may determine whether the latest SAK is receiving. In response to a determination that the latest SAK is not receiving, it may indicate that at the time of failure of primary management engine 112, secure associations for receive SCs were created, and MACsec was waiting for hardware status. In such case, secondary management engine 114 may continue to wait for hardware status of SA creation.

In response to a determination that the latest SAK is receiving, secondary management engine 114 may enable CP State machine state to a Receiving state. A Receiving state allows MACsec capable device 104 to receive MACsec frames. Secondary management engine 114 may generate secure associations for each receive secure channel using the latest key.

Secondary management engine 114 may determine whether the latest SAK is transmitting. In response to a determination that the latest SAK is not transmitting, secondary management engine 114 may determine a status of electedSelf parameter. In response to a determination that the status of the electedSelf parameter is true, secondary management engine 114 may wait for allReceiving status. An “allReceiving status” may be set if all the live partners of the principal actor that are capable of receiving frames transmitted using the transmit SA with the SAK key have indicated that reception is enabled. In response to a determination that the status of the electedSelf parameter is false, secondary management engine 114 may wait for serverTransmitting status. The “serverTransmitting status” may be set by MKA if the elected Key Server indicates that it is transmitting using the SAK identified by distributedKI. A “distributedKI” may include the key identifier for the last key distributed.

In response to a determination that the latest SAK is transmitting, secondary management engine 114 may enable CP State machine state to a Transmitting state. In Transmitting state, MAC sec capable device 104 may be in a steady state with the latest key transmitting and receiving. Secondary management engine 114 may generate a secure association on transmit secure channel.

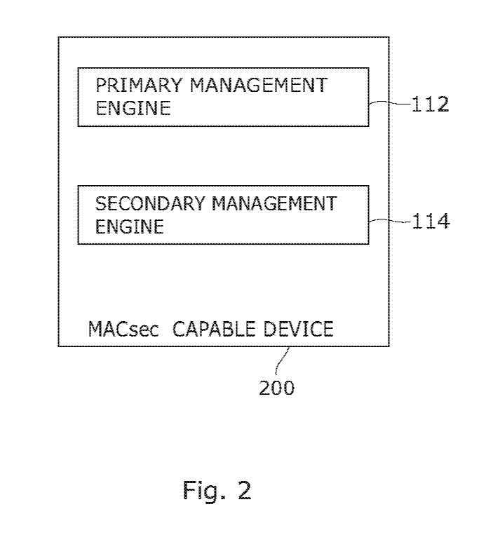

FIG. 2 is a bock diagram of an example MACsec capable device 200 for providing a failover. In an example, MACsec capable device 200 may be analogous to MACsec capable devices 104 or 106 of FIG. 1, in which like reference numerals correspond to the same or similar, though perhaps not identical, components. For the sake of brevity, components or reference numerals of FIG. 2 having a same or similarly described function in FIG. 1 are not being described in connection with FIG. 2. Said components or reference numerals may be considered alike.

In an example, MACsec capable device 200 may be a network device. For example, MACsec capable device 200 may be a network switch, a network router, a virtual switch, and a virtual router. In another example, MACsec capable device 200 may be a computing device capable of executing machine-readable instructions. For example, MACsec capable 200 device may be a server, a desktop computer, a notebook computer, a tablet computer, a thin client, a mobile device, a personal digital assistant (PDA), and the like.

In an example, MACsec capable device 200 may include a primary management engine 112 and a secondary management engine 114. In an example, primary management engine 112 may run a protocol of MACsec standard in the MACsec capable device. Primary management engine 112 may determine whether a parameter related to a protocol of MACsec standard on MACsec capable device 104 has changed. In an example, primary management engine 112 may receive a keepalive packet from a peer MACsec capable device (for example, 106). Primary management engine 112 may determine from the keepalive packet whether a parameter related to a protocol of MACsec standard on peer MACsec capable device 106 has changed. In response to a determination that the parameter related to the protocol of MACsec standard on the MACsec capable device (or peer MACsec capable device) has changed, primary management engine 112 may synchronize data related to the parameter to a secondary management engine 114 in the MACsec capable device. The secondary management engine 114 may act as a failover component for the primary management engine 112. Secondary management engine 114 may determine that the primary management engine 112 has failed. In response to a determination that the primary management engine 112 has failed, secondary management may recreate latest state of the protocol of MACsec standard in the MACsec capable device prior to the failure of the primary management engine 112, based on the data related to the parameter.

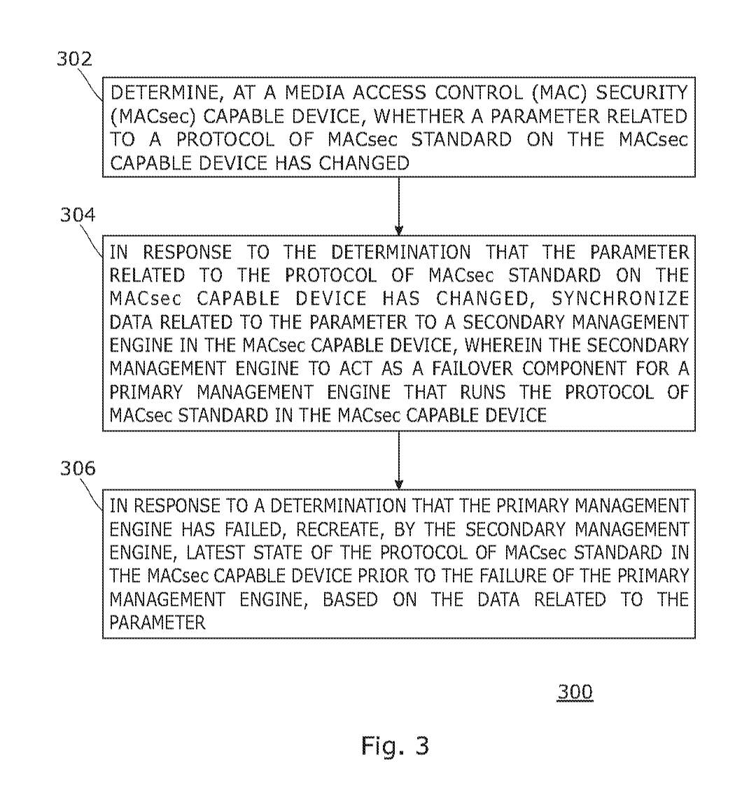

FIG. 3 is a flow chart of an example method 300 of providing a failover in a MACsec capable device. The method 300, which is described below, may be partially executed on a computing device such as MACsec capable devices 104 and 106 of FIG. 1 or 200 of FIG. 2. However, other suitable computing devices may execute method 300 as well.

At block 302, a primary management engine (for example, 112) in a Media Access Control (MAC) Security (MACsec) capable device may determine whether a parameter related to a protocol of MACsec standard on the MACsec capable device has changed. The primary management engine may be responsible for running a protocol of MACsec standard in the MACsec capable device At block 304, in response to the determination that the parameter related to the protocol of MACsec standard on the MACsec capable device has changed, the primary management engine may synchronize data related to the parameter to a secondary management engine (for example, 114) in the MACsec capable device. The secondary management engine may act as a failover component for the primary management engine. At block 306, in response to a determination that the primary management engine has failed, the secondary management engine may recreate the latest state of the protocol of MACsec standard in the MACsec capable device prior to the failure of the primary management engine, based on the data related to the parameter.

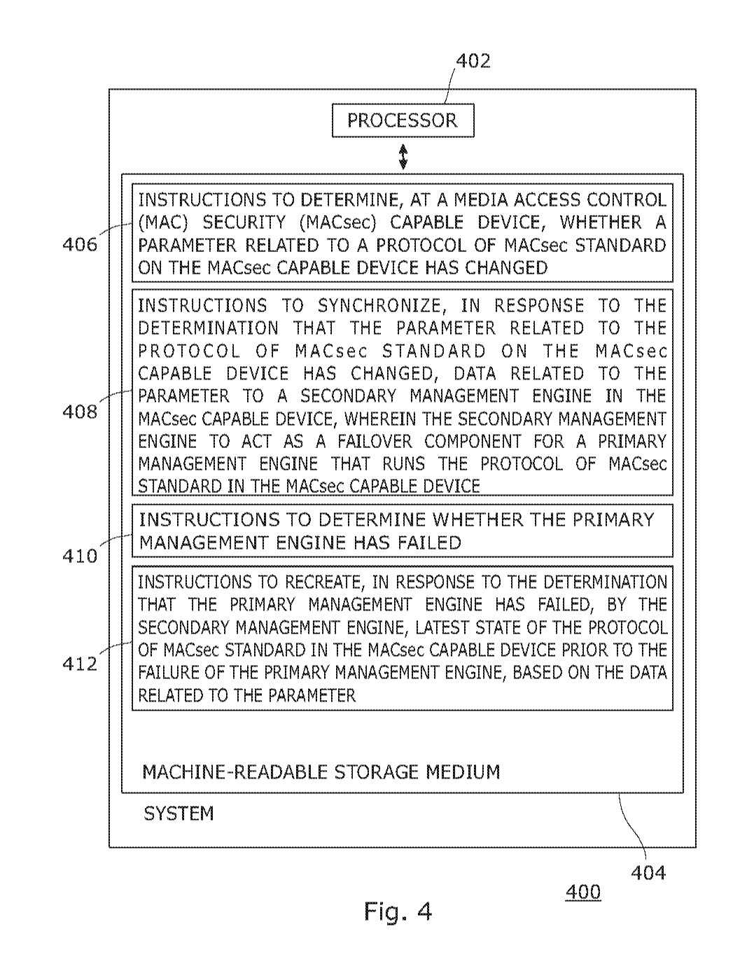

FIG. 4 is a block diagram of an example system 400 including instructions in a machine-readable storage medium for providing a failover in a MACsec capable device. System 400 includes a processor 402 and a machine-readable storage medium 404 communicatively coupled through a system bus. In an example, system 400 may be analogous to MACsec capable devices 112 and 114 of FIGS. 1, and 200 of FIG. 2. Processor 402 may be any type of Central Processing Unit (CPU), microprocessor, or processing logic that interprets and executes machine-readable instructions stored in machine-readable storage medium 404. Machine-readable storage medium 404 may be a random access memory (RAM) or another type of dynamic storage device that may store information and machine-readable instructions that may be executed by processor 402. For example, machine-readable storage medium 404 may be Synchronous DRAM (SDRAM), Double Data Rate (DDR), Rambus DRAM (RDRAM), Rambus RAM, etc. or storage memory media such as a floppy disk, a hard disk, a CD-RCM, a DVD, a pen drive, and the like. In an example, machine-readable storage medium may be a non-transitory machine-readable medium. Machine-readable storage medium 404 may store instructions 406, 408, 410, and 412. In an example, instructions 406 may be executed by processor 402 to determine, at a Media Access Control (MAC) Security (MACsec) capable device, whether a parameter related to a protocol of MACsec standard on the MACsec capable device has changed. Instructions 408 may be executed by processor 402 to synchronize, in response to the determination that the parameter related to the protocol of MACsec standard on the MACsec capable device has changed, data related to the parameter to a secondary management engine 114 in the MACsec capable device. The secondary management engine 114 may act as a failover component for a primary management engine 112 that runs the protocol of MACsec standard in the MACsec capable device. Instructions 410 may be executed by processor 402 to determine whether the primary management engine 112 has failed. In response to the determination that the primary management engine 112 has failed, instructions 412 may be executed by processor 402 to recreate, by the secondary management engine 114, latest state of the protocol of MACsec standard in the MACsec capable device prior to the failure of the primary management engine 112, based on the data related to the parameter. In an example, machine-readable storage medium 404 may further store instructions to send MICA keepalive packets from the MACsec capable device, in response to recreating the latest state of MACsec protocol on the secondary management engine.

For the purpose of simplicity of explanation, the example method of FIG. 3 is shown as executing serially, however it is to be understood and appreciated that the present and other examples are not limited by the illustrated order. The example systems of FIGS. 1, 2, and 4, and method of FIG. 3 may be implemented in the form of a computer program product including computer-executable instructions, such as program code, which may be run on any suitable computing device in conjunction with a suitable operating system (for example, Microsoft Windows, Linux, UNIX, and the like). Examples within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration. Although the solution has been described in conjunction with a specific example thereof, numerous modifications may be possible without materially departing from the teachings of the subject matter described herein. Other substitutions, modifications and changes may be made without departing from the spirit of the present solution. All of the features disclosed in this specification (including any accompanying claims, abstract and drawings), and/or all of the stages of any method or process so disclosed, may be combined in any combination, except combinations where at least some of such features and/or stages are mutually exclusive.

I/We claim:

1. A method comprising:
determining, at a Media Access Control (MAC) Security (MACsec) capable device, whether a parameter related to a protocol of MACsec standard on the MACsec capable device has changed;
in response to the determination that the parameter related to the protocol of MACsec standard on the MACsec capable device has changed, synchronizing data related to the parameter to a secondary management engine in the MACsec capable device, wherein the secondary management engine to act as a failover component for a primary management engine that runs the protocol of MACsec standard in the MACsec capable device; and
in response to a determination that the primary management engine has failed, recreating, by the secondary management engine, latest state of the protocol of MACsec standard in the MACsec capable device prior to the failure of the primary management engine, based on the data related to the parameter.

2. The method of claim 1, further comprising:
determining, from a keepalive packet received from a peer MACsec capable device, whether a parameter related to the protocol of MACsec standard on the peer MACsec capable device has changed; and
in response to the determination that the parameter related to the protocol of MACsec standard on the peer MACsec capable device has changed, synchronizing data related to the parameter to a secondary management engine in the MACsec capable device.

3. The method of claim 1, wherein the synchronizing comprises:
storing the data related to the parameter in a database associated with the primary management engine;
synchronizing the database associated with the primary management engine with a database associated with the secondary management engine; and
accessing the database associated with the secondary management engine to retrieve the data related to the parameter.

4. The method of claim 1, wherein the synchronizing comprises:
storing the data related to the parameter in a common database accessible to the primary management engine and the secondary management engine;
accessing the common database to retrieve the data related to the parameter.

5. A Media Access Control (MAC) Security (MACsec) capable device comprising:
a primary management engine to:
determine whether a parameter related to a protocol of MACsec standard on the MACsec capable device has changed, wherein the primary management engine runs the protocol of MACsec standard in the MACsec capable device;
synchronize data related to the parameter to a secondary management engine in the MACsec capable device in response to the determination that the parameter related to the protocol of MACsec standard on the MACsec capable device has changed, wherein the secondary management engine to act as a failover component for the primary management engine; and
the secondary management to recreate, in response to a determination that the primary management engine has failed, latest state of the protocol of MACsec standard in the MACsec capable device prior to the failure of the primary management engine, based on the data related to the parameter.

6. The system of claim 5, wherein the parameter includes at least one of a controlledPortEnabled, an electedSelf, a Secure Association Key (SAK) Use parameter set, and a Live Peer List.

7. The system of claim 5, wherein recreating includes recreating a Controlled Port (CP) State machine state on the MACsec capable device.

8. A non-transitory machine-readable storage medium comprising instructions, the instructions executable by a processor to:
determine, at a Media Access Control (MAC) Security (MACsec) capable device, whether a parameter related to a protocol of MACsec standard on the MACsec capable device has changed;
synchronize, in response to the determination that the parameter related to the protocol of MACsec standard on the MACsec capable device has changed, data related to the parameter to a secondary management engine in the MACsec capable device, wherein the secondary management engine to act as a failover component for a primary management engine that runs the protocol of MACsec standard in the MACsec capable device;
determine whether the primary management engine has failed; and
in response to the determination that the primary management engine has failed, recreate, by the secondary management engine, latest state of the protocol of MACsec standard in the MACsec capable device prior to the failure of the primary management engine, based on the data related to the parameter.

9. The storage medium of claim 3, wherein the instructions to recreate include instructions to recreate a Controlled Port (CP) State machine state on the MACsec capable device.

10. The storage medium of claim 9, wherein the instructions to recreate the CP State machine state on the MACsec capable device include instructions to:
determine a status of a controlledPortEnabled parameter;
in response to the determination that the status of the controlledPortEnabled parameter is true, enable the Controlled Port (CP) State machine state to a Secure state;
generate a transmit secure channel (SC); and
generate receive secure channels for live peers of the MACsec capable device.

11. The storage medium of claim 10, further comprising instructions to:
determine whether an old Secure Association Key (SAK) is transmitting; and
generate, in response to the determination that the old SAK is transmitting, a secure association (SA) on the transmit secure channel using the old SAK.

12. The storage medium of claim 11, further comprising instructions to:
determine whether the old SAK is transmitting but not receiving; and
enable, in response to the determination that the old SAK is transmitting but not receiving, the CP State machine state to an Assert state.

13. The storage medium of claim 12, further comprising instructions to:
generate, in response to the determination that the old SAK is receiving, secure associations on receive secure channels using the old SAK.

14. The storage medium of claim 10, further comprising instructions to:
determine, in response to the determination that the old SAK is not transmitting, a state of a latest SAK,

15. The storage medium of claim 14, further comprising instructions to:
enable the CP State machine state to a Receiving state; and
generate secure associations for each receive secure channel using the latest key, in response to the determination that the latest SAK is receiving:

16. The storage medium of claim 15, further comprising instructions to:
determine whether the latest SAK is transmitting;
determine, in response to the determination that the latest SAK is not transmitting, determining a status of electedSelf parameter;
in response to the determination that the status of the electedSelf parameter is true, wait for allReceiving status.

17. The storage medium of claim 16, further comprising instructions to:
wait, in response to the determination that the status of the electedSelf parameter is false, for serverTransmitting status.

18. The storage medium of claim 16, further comprising instructions to:
enable the CP State machine state to a Transmitting state; and
generate a secure association on the transmit secure channel, in response to a determination that the latest SAK is transmitting:

19. The storage medium of claim 16, wherein the data related to the parameter is part of a keepalive message of MACsec Key Agreement (MKA) protocol.

20. The storage medium of claim 16, further comprising instructions to:
send MKA keepalive packets from the MACsec capable device, in response to recreating the latest state of MACsec protocol on the secondary management engine.
